(19) United States
(12) Patent Application Publication
(10) Pub. No.: US 2024/0392071 A1
(43) Pub. Date: Nov. 28, 2024

(54) SOLUBLE POLYIMIDE BINDER FOR CATHODE OF LITHIUM SECONDARY BATTERY, MANUFACTURING METHOD THEREOF, AND LITHIUM SECONDARY BATTERY COMPRISING SAME

(71) Applicant: IPITECH INC, Daejeon (KR)

(72) Inventors: Ho Young PARK, Daejeon (KR); Kye Ung LEE, Daejeon (KR); Jun Yun LEE, Daejeon (KR)

(21) Appl. No.: 18/695,872

(22) PCT Filed: Jul. 29, 2022
(86) PCT No.: PCT/KR2022/011249

§ 371 Date: Mar. 27, 2024

(30) Foreign Application Priority Data
Sep. 30, 2021 (KR) 10-2021-0129600

(51) Int. Cl. C08G 73/14; H01M 4/02; H01M 4/04; H01M 4/62; H01M 10/052

(52) U.S. Cl. CPC C08G 73/14; H01M 4/04; H01M 4/622; H01M 10/052; H01M 2004/028

(57) ABSTRACT

Disclosed are a soluble polyimide binder for a cathode of a lithium secondary battery capable of securing high heat resistance, safety, and excellent battery performance by using the soluble polyimide binder as a cathode binder for a lithium secondary battery, a manufacturing method thereof, and a lithium secondary battery comprising same.

### FIELD

The present disclosure relates to a soluble polyimide binder for a positive electrode of a lithium secondary battery, a preparation method thereof, and a lithium secondary battery including the same. More specifically, the present disclosure relates to a soluble polyimide binder for a positive electrode of a lithium secondary battery that may be used as a binder for a positive electrode of a lithium secondary battery to secure high heat resistance, safety, and excellent battery performance, and relates to a preparation method thereof, and a lithium secondary battery including the same.

### DESCRIPTION OF RELATED ART

In a conventional lithium secondary battery, PVdF (Polyvinylidenefluoride) is generally used as a binder for a positive electrode. When using PVdF as a binder for a positive electrode of a lithium secondary battery, there were problems such as oxidation instability of the electrolyte, instability of the positive electrode-electrolyte interface, deterioration of the binder, and lowering of electrode bonding ability in a high temperature and high voltage environment.

To solve this problem, there have been efforts to use a polyimide resin as a binder for a positive electrode for a lithium secondary battery.

In order to use this polyimide resin as a binder for a positive electrode of the lithium secondary battery, a thermal or chemical imidization process is required. When an electrode mixture of non-imidized polyamic acid with a positive electrode active material and a conductive material is prepared and is coated on an Al-based current collector plate, heat treatment at a high temperature should be performed thereon for the imidization. During this high-temperature process, there is a risk that the Al-based current collector plate may be oxidized, and there is a problem that a surface of the positive electrode active material is deteriorated due to reaction with water molecules produced during the imidization process.

Furthermore, the chemical imidization process used conventionally involves performing a chemical imidization process on polyamic acid in a resin state at a low temperature of about 80° C., followed by a separate washing process to prepare polyimide resin in a form of granules.

However, in the chemical imidization process used conventionally, the washing process is required such that a large amount of waste water is produced. Although an amount of the wastewater may vary depending on a scale, approximately 20 L or larger of the wastewater is produced based on 500 g. Furthermore, the washing process takes a long time, for example, at least 5 days or larger. Accordingly, there is an issue of a raw material cost, and the process takes a long time, thereby producing a large amount of wastewater.

Related prior literature includes Korean Patent Application Publication No. 10-1999-025576 (published on Apr. 6, 1999), which describes a new soluble polyimide resin with an alkoxy substituent and a preparation method thereof.

### DISCLOSURE

### Technical Purpose

A purpose of the present disclosure is to provide a soluble polyimide binder for a positive electrode of a lithium secondary battery that may be used as a binder for a positive electrode of a lithium secondary battery to secure high heat resistance, safety, and excellent battery performance, and a preparation method thereof, and a lithium secondary battery including the same.

### Technical Solution

A method for preparing a soluble polyimide binder for a positive electrode of a lithium secondary battery according to embodiments of the present disclosure for achieving the above purpose includes (a) dissolving a diamine-based monomer and a dianhydride monomer in an organic solvent to prepare a mixed solution; (b) polymerizing the mixed solution to produce polyamic acid and then adding a catalyst thereto; and (c) heating the polyamic acid having the catalyst added thereto to a high temperature of 160 to 180° C. to imidize the polyamic acid to produce the soluble polyimide binder, wherein in the (c), the soluble polyimide binder includes a copolymer containing a repeating unit represented by a following Chemical Formula 1, a repeating unit represented by a following Chemical Formula 2, and a repeating unit represented by a following Chemical Formula 3, and the soluble polyimide binder has a glass transition temperature of 100 to 300° C.:

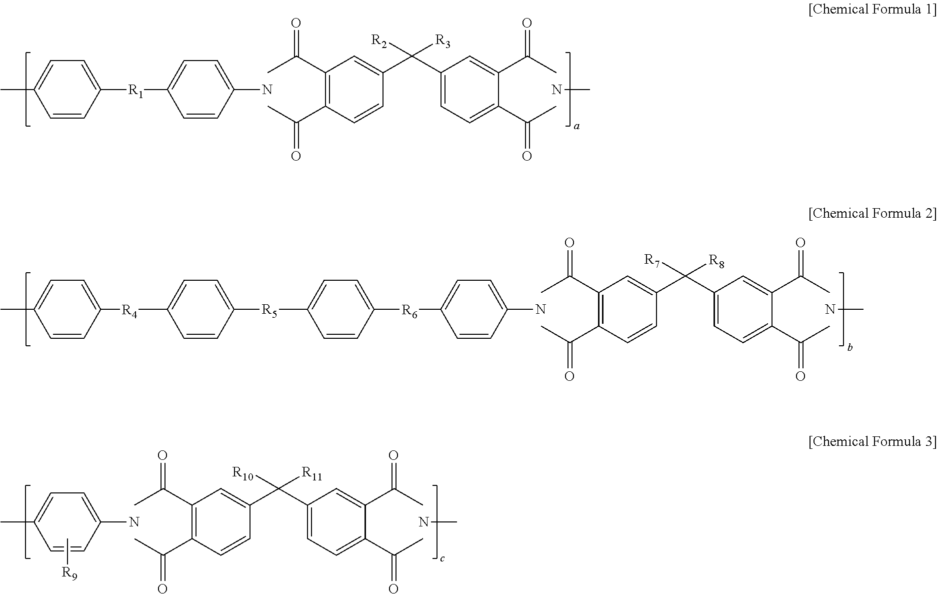

where in the Chemical Formula 1, the Chemical Formula 2, and the Chemical Formula 3, each of R₁, R₄ to R₆, and R₉ independently represents at least one functional group selected from a group consisting of a sulfonic acid group, an ether group, and a carboxyl group, each of R₂, R₃, R₇, R₈, R₁₀, and R₁₁ independently represents one functional group selected from CH₃₋ₓFₓ, wherein x is an integer from 1 to 3, and each of a, b, and c is independently an integer from 2 to 200.

In the (b), the polymerization is conducted for 3 to 12 hours under a temperature condition of −10° C. to 25° C.

In the (b), the catalyst includes at least one of a dehydrating agent and a chemical curing agent, wherein the dehydrating agent includes acetic anhydride, wherein the chemical curing agent is selected from tertiary amines including 3-methylpyridine, pyridine, triethylamine, and isoquinoline.

In the (c), the high temperature heating is conducted for 10 to 30 hours in a nitrogen atmosphere.

In the (c), the soluble polyimide binder has a solid content in a range of 20 to 23 wt % and has a viscosity in a range of 5,000 to 30,000 cps.

A soluble polyimide binder for a positive electrode of a lithium secondary battery according to embodiments of the present disclosure for achieving the above purpose includes a copolymer containing a repeating unit represented by a following Chemical Formula 1, a repeating unit represented by a following Chemical Formula 2, and a repeating unit represented by a following Chemical Formula 3; a catalyst; and an organic solvent, wherein the soluble polyimide binder has a glass transition temperature of 100 to 300° C.:

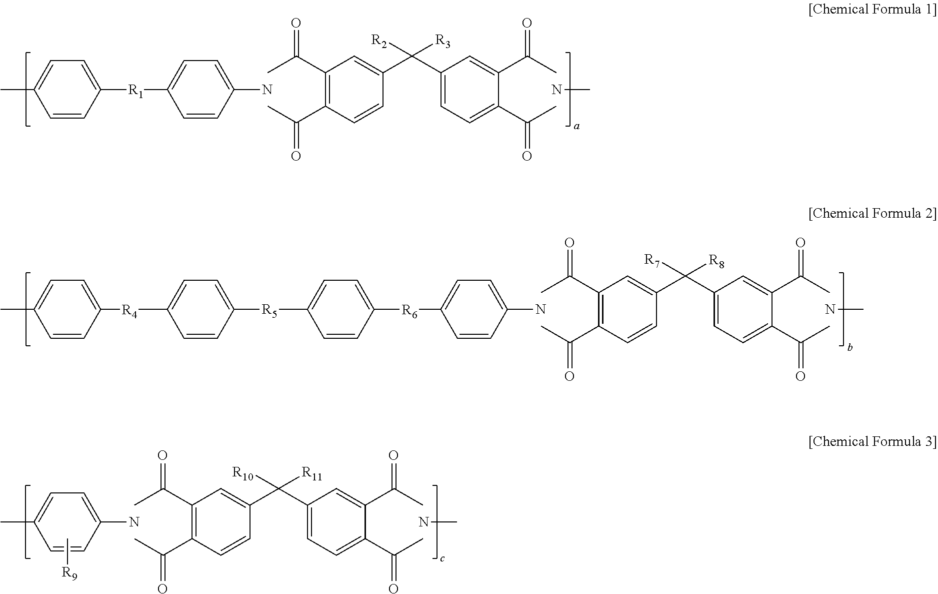

where in the Chemical Formula 1, the Chemical Formula 2, and the Chemical Formula 3, each of R₁, R₄ to R₆, and R₉ independently represents at least one functional group selected from a group consisting of a sulfonic acid group, an ether group, and a carboxyl group, each of R₂, R₃, R₇, R₈, R₁₀, and R₁₁ independently represents one functional group selected from CH₃₋ₓFₓ, wherein x is an integer from 1 to 3, and each of a, b, and c is independently an integer from 2 to 200.

In the soluble polyimide binder, the catalyst includes at least one of a dehydrating agent and a chemical curing agent, wherein the dehydrating agent includes acetic anhydride, wherein the chemical curing agent is selected from tertiary amines including 3-methylpyridine, pyridine, triethylamine, and isoquinoline.

In the soluble polyimide binder, the soluble polyimide binder has a solid content in a range of 20 to 23 wt % and has a viscosity in a range of 5,000 to 30,000 cps.

A lithium secondary battery according to embodiments of the present disclosure for achieving the above purpose includes a positive electrode including an active material, a binder, and a conductive material; a negative electrode spaced apart from the positive electrode and including a negative electrode active material, a binder, and a conductive material; a separator disposed between the negative electrode and the positive electrode to prevent short circuit between the negative electrode and the positive electrode; and an electrolyte solution impregnated into the negative electrode and the positive electrode, wherein the binder of the positive electrode is a soluble polyimide binder, wherein the soluble polyimide binder includes: a copolymer containing a repeating unit represented by a following Chemical Formula 1, a repeating unit represented by a following Chemical Formula 2, and a repeating unit represented by a following Chemical Formula 3; a catalyst; and an organic solvent, wherein the soluble polyimide binder has a glass transition temperature of 100 to 300° C.:

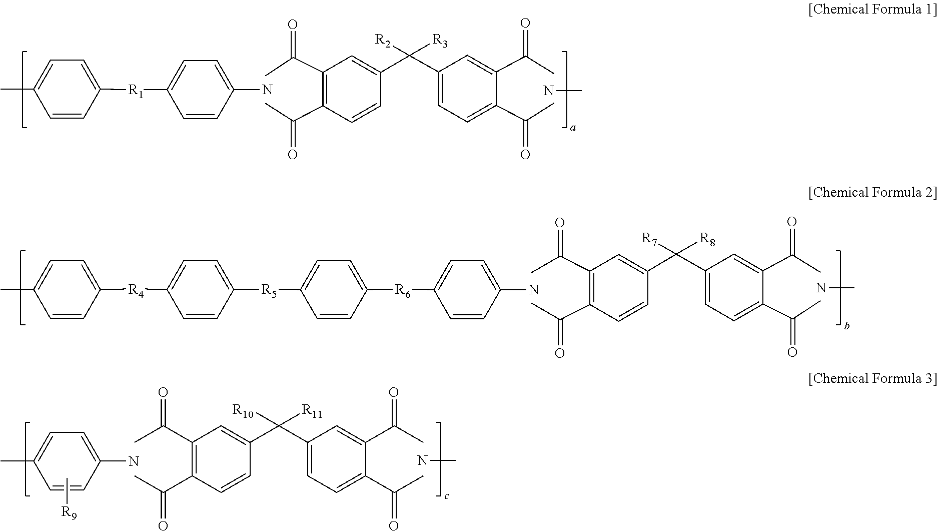

where in the Chemical Formula 1, the Chemical Formula 2, and the Chemical Formula 3, each of R₁, R₄ to R₆, and R₉ independently represents at least one functional group selected from a group consisting of a sulfonic acid group, an ether group, and a carboxyl group, each of R₂, R₃, R₇, R₈, R₁₀, and R₁₁ independently represents one functional group selected from CH₃₋ₓFₓ, wherein x is an integer from 1 to 3, and each of a, b, and c is independently an integer from 2 to 200.

### Technical Effects

In the soluble polyimide binder for the positive electrode of the lithium secondary battery, the preparation method thereof, and the lithium secondary battery including the same according to the present disclosure, while a content of a large-sized functional group such as —CF₃ is reduced in the binder, one or more types of functional groups including —O—, ═SO₂ and —COOH are introduced to the binder, such that the binder exhibits electrode characteristics such as reduced resistance and improved wettability, compared to a PVdF binder or a polyimide binder containing a large amount of the large-sized functional group —CF₃.

As a result, in the soluble polyimide binder for the positive electrode of the lithium secondary battery, the preparation method thereof, and the lithium secondary battery including the same according to the present disclosure, the binder may have improved interfacial adhesion with the positive electrode active material, and may have excellent thermal stability, and may secure electrode structure stability at high voltage, thereby improving physical properties such as high heat resistance, safety, and excellent battery performance.

### BRIEF DESCRIPTION OF THE DRAWINGS

FIG. 1 is a process flow chart showing a method for preparing a soluble polyimide binder for a positive electrode of a lithium secondary battery according to an embodiment of the present disclosure.

FIG. 2 and FIG. 3 are SEM photos showing a cut surface of a positive electrode after a charge and discharge test on a lithium secondary battery according to each of Present Examples 1 to 2 and Comparative Example 1.

FIG. 4 is a graph showing a result of a high-temperature and high-voltage charge/discharge test on a lithium secondary battery according to each of Present Examples 1 and Comparative Examples 1 to 2.

FIG. 5 is a graph showing cycle characteristics of a lithium secondary battery according to each of Present Example 1 and Comparative Examples 1 to 2.

FIG. 6 is a graph showing a result of a high-temperature and high-voltage charge/discharge test on a lithium secondary battery according to each of Present Examples 2 to 3 and Comparative Examples 1 to 2.

### DETAILED DESCRIPTIONS

The advantages and features of the present disclosure, and a method for achieving them will become clear by referring to embodiments as described in detail below along with the accompanying drawings. However, the present disclosure is not limited to the embodiments disclosed below and will be implemented in various different forms. The embodiment is provided only to ensure that the present disclosure is complete and to fully inform the skilled person to the art of the scope of the present disclosure. The present disclosure is only defined by the scope of the claims. Like reference numerals refer to like elements herein.

Hereinafter, with reference to the attached drawings, a soluble polyimide binder for a positive electrode of a lithium secondary battery according to a preferred embodiment of the present disclosure, a preparing method thereof, and a lithium secondary battery including the same will be specifically described below.

### Method for Preparing Soluble Polyimide Binder for Positive Electrode of Lithium Secondary Battery

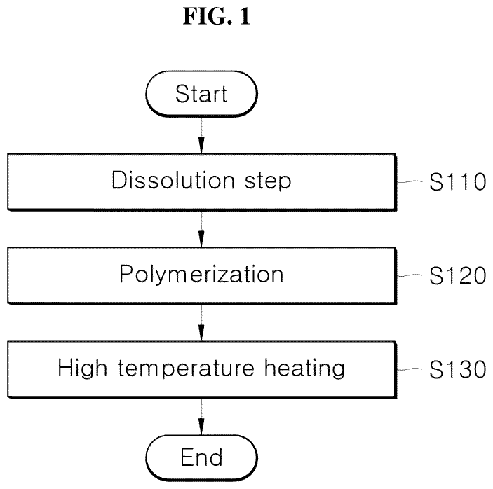

FIG. 1 is a process flowchart showing a method for preparing a soluble polyimide binder for a positive electrode of a lithium secondary battery according to an embodiment of the present disclosure.

Referring to FIG. 1, a method for preparing a soluble polyimide binder for a positive electrode of a lithium secondary battery according to an embodiment of the present disclosure includes a dissolution step S110, a polymerization step S120, and a high temperature heating step S130.

### Dissolution

In the dissolution step S110, a diamine-based monomer and a dianhydride monomer are dissolved in an organic solvent.

In this regard, the diamine-based monomer may include one or more types selected from 4,4-oxydianiline (ODA), m-bis(4-(4-aminophenoxy)phenyl)sulfone (m-BAPS), 2,2-bis(4-(4-aminophenoxy)phenyl)propane (BAPP), 1,3-bis(4-aminophenoxy)benzene (TPER), etc.

The dianhydride monomer may include one or more selected from 4,4′-(hexafluoroisopropylidene)diphthalic anhydride (6FDA), biphenyl-tetracarboxylic acid (BPDA), 4,4′-oxydiphthalic anhydride (ODPA), 4,4′-(4,4′-isopropylidene-diphenoxy)bis(phthalic anhydride) (BPADA), etc.

The organic solvent may include one or more selected from DMF (dimethylformamide), NMP (N-methyl-2-pyrrolidone), DMSO (Dimethyl Sulfoxide), DMAc (Dimethylacetamide), methyl lactate, ethyl lactate, n-propyl lactate, n-butyl lactate, acetone, diethylacetate, etc.

In this step, the dissolution is preferably carried out by adding the diamine-based monomer and the dianhydride monomer to the organic solvent to prepare a mixed solution and performing ultrasonic treatment on the mixed solution while stirring the mixed solution at a speed of 100 to 200 rpm for 1 to 6 hours.

In this step, the ultrasonic treatment is preferably performed under output power conditions of 35 to 45 kHz and 140 to 220 W. When the ultrasonic output frequency is smaller than 140 W or the ultrasonic treatment time is smaller than 1 hour, there is a risk that the diamine-based monomer and the dianhydride monomer may not be uniformly mixed in the organic solvent. Conversely, when the ultrasonic output frequency exceeds 220 W or the ultrasonic treatment time exceeds 6 hours, this may act as a factor in increasing a preparation cost and time without further increasing the effectiveness, thereby making the process uneconomical.

### Polymerization

In the polymerization step (S120), the dissolved mixed solution is polymerized to produce a polyamic acid, and then a catalyst is added thereto.

In this step, the polymerization is preferably carried out for 3 to 12 hours under temperature conditions of −10° C. to 25° C.

In this regard, the catalyst may include one or more selected from a dehydrating agent and a chemical curing agent. It is more preferable to add the dehydrating agent and the chemical curing agent thereto at the same time.

Acetic anhydride may be used as the dehydrating agent.

The chemical curing agent may include one or more types selected from tertiary amines including 3-methylpyridine, pyridine, triethylamine, and isoquinoline.

This catalyst may be added in an amount of 200 mol % or smaller based on 100 mol % of the diamine-based monomer. More preferably, the catalyst may be added in an amount of 20 mol % or smaller based on 100 mol % of the diamine-based monomer.

### High Temperature Heating

In the high temperature heating step (S130), the polyamic acid is imidized by heating the polyamic acid at a high temperature of 160 to 180° C. to produce a soluble polyimide binder.

In this step, the high temperature heating is preferably performed at 160 to 180° C. for 10 to 30 hours. When the chemical imidization process is performed via the high-temperature heating, it is more preferable to carry out the process in a nitrogen gas atmosphere to create an inert environment.

In this high temperature heating, when the heating temperature is lower than 160° C., a content of a large-sized functional group such as —CF₃ is reduced, thus making it difficult to perform a ring-closing reaction from the polyamic acid to polyimide, which may result in a low imidization level. On the other hand, in the high temperature heating, when the heating temperature exceeds 180° C., this is undesirable because there is a risk that an entirety of the organic solvent may volatilize during the chemical imidization heat treatment.

The chemical imidization process is performed via the high temperature heating to prepare the soluble polyimide binder including a copolymer containing a repeating unit represented by a following Chemical Formula 1, a repeating unit represented by a following Chemical Formula 2, and a repeating unit represented by a following Chemical Formula 3.

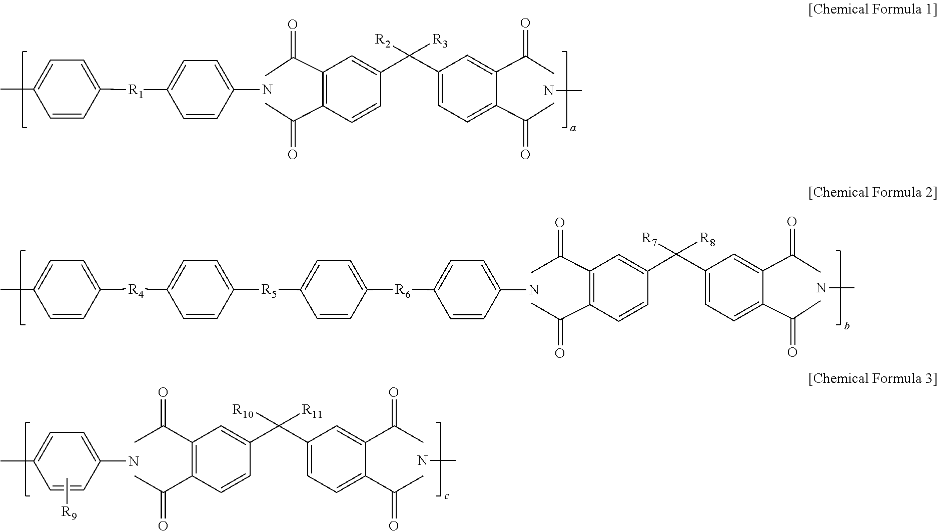

where in the Chemical Formula 1, the Chemical Formula 2, and the Chemical Formula 3, each of R₁, R₄ to R₆, and R₉ independently represents at least one functional group selected from a group consisting of a sulfonic acid group, an ether group, and a carboxyl group, each of R₂, R₃, R₇, R₈, R₁₀, and R₁₁ independently represents one functional group selected from CH₃₋ₓFₓ, wherein x is an integer from 1 to 3, and each of a, b, and c is independently an integer from 2 to 200.

In the Chemical Formula 1, the Chemical Formula 2, and the Chemical Formula 3, each of a and b may be independently an integer from 2 to 200, and more specifically, an integer from 30 to 80. When the above range is satisfied, this may be advantageous for formation of a surface protective layer at a surface of the positive electrode active material, and may minimize performance degradation and may secure safety during repeated charging and discharging.

The copolymer is not greatly limited in terms of a form thereof, but may be at least one selected from an alternating copolymer, a random copolymer, a block copolymer, and a graft copolymer.

The soluble polyimide binder for the positive electrode of the lithium secondary battery according to an embodiment of the present disclosure may not only increase the adhesion thereof with the positive electrode active material and the conductive material, but also prevent detachment thereof from a positive electrode current collector. In particular, the binder may constitute a surface protection layer at a surface of the positive electrode active material, thereby ensuring electrode stability, especially thermal stability and high voltage stability. Thus, the binder is more effective in improving the stability of the electrode structure and battery characteristics, specifically, a high rate, a high capacity, cycle characteristics, and lifespan characteristics.

The chemical imidization process used conventionally involves performing a chemical imidization process on the polyamic acid in a state of a resin at a low temperature of about 80° C., followed by a separate washing process to prepare polyimide resin in a form of granules. In this case, a large amount of wastewater is produced because a cleaning process is required.

In contrast thereto, in accordance with the present disclosure, during a synthesis process of the imidization via the high-temperature heating, the chemical imidization process via the high-temperature heating of 160 to 180° C. is introduced. Thus, the soluble polyimide solution not subjected to a separate washing process can be used as the binder for the positive electrode of the lithium secondary battery, such that the washing process is removed and thus the wastewater production is minimized.

Accordingly, the soluble polyimide binder has a solid content in a range of 20 to 23 wt % and has a viscosity in a range of 5,000 to 30,000 cps.

In addition, the soluble polyimide binder preferably has a glass transition temperature in a range of 100 to 300° C., and, more preferably, has a glass transition temperature in a range of 220 to 250° C. The reason why the soluble polyimide binder is limited to have a glass transition temperature in a range of 100 to 300° C. is because a drying temperature when manufacturing a positive electrode for a lithium secondary battery is approximately 120° C., and thus, it is desirable to heat-treat the soluble polyimide binder at a temperature of 100° C. or higher.

In general, a conventional polyimide binder contains a large-sized functional group such as —CF₃ in the copolymer and has an aromatic-based rigid structure, and thus may be expected to have high heat resistance (high Tg and Td) but wettability of the binder with the electrolyte is poor, so that the electrode resistance may increase.

In contrast thereto, regarding the soluble polyimide binder for the positive electrode of the lithium secondary battery according to an embodiment of the present disclosure, a content of a large-sized functional group such as —CF₃ is reduced in the binder, while one or more types of functional groups including —O—, ═SO₂ and —COOH are introduced to the binder, such that the binder exhibits electrode characteristics such as reduced resistance and improved wettability, compared to a PVdF binder or a polyimide binder containing a large amount of the large-sized functional group —CF₃, and thus may improve physical properties such as high heat resistance, safety, and excellent battery performance.

### Soluble Polyimide Binder for Positive Electrode of Lithium Secondary Battery

The soluble polyimide binder for the positive electrode of the lithium secondary battery according to the present disclosure includes a copolymer containing a repeating unit represented by a following Chemical Formula 1, a repeating unit represented by a following Chemical Formula 2, and a repeating unit represented by a following Chemical Formula 3; a catalyst; and an organic solvent:

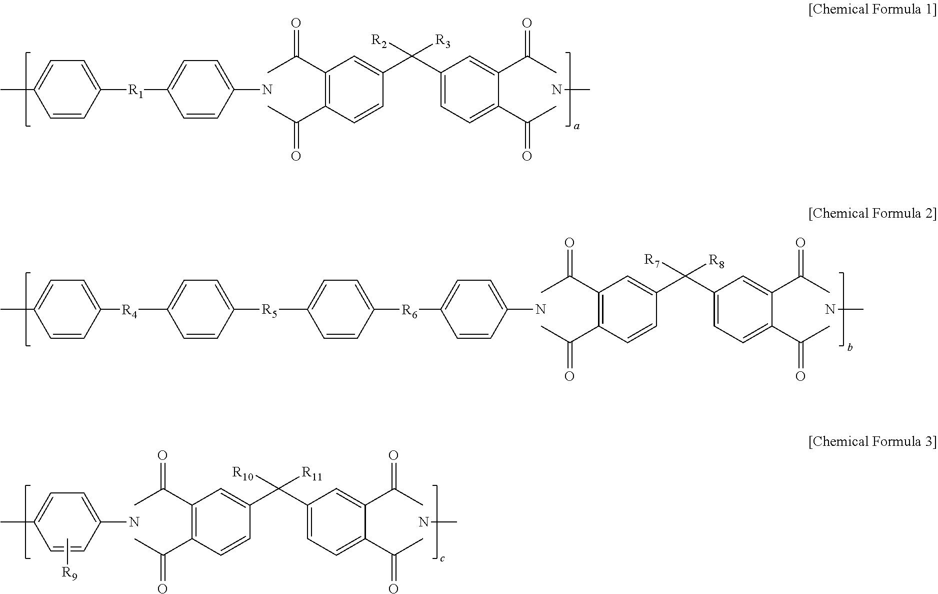

where in the Chemical Formula 1, the Chemical Formula 2, and the Chemical Formula 3, each of R₁, R₄ to R₆, and R₉ independently represents at least one functional group selected from a group consisting of a sulfonic acid group, an ether group, and a carboxyl group, each of R₂, R₃, R₇, R₈, R₁₀, and Ru independently represents one functional group selected from CH₃₋ₓFₓ, wherein x is an integer from 1 to 3, and each of a, b, and c is independently an integer from 2 to 200.

The soluble polyimide binder for the positive electrode of the lithium secondary battery according to an embodiment of the present disclosure may not only increase the adhesion thereof with the positive electrode active material and the conductive material, but also prevent detachment thereof from a positive electrode current collector. In particular, the binder may constitute a surface protection layer at a surface of the positive electrode active material, thereby ensuring electrode stability, especially thermal stability and high voltage stability. Thus, the binder is more effective in improving the stability of the electrode structure and battery characteristics, specifically, a high rate, a high capacity, cycle characteristics, and lifespan characteristics.

In this regard, the soluble polyimide binder preferably has a glass transition temperature in a range of 100 to 300° C., and, more preferably, has a glass transition temperature in a range of 220 to 250° C. The reason why the soluble polyimide binder is limited to have a glass transition temperature in a range of 100 to 300° C. is because a drying temperature when manufacturing a positive electrode for a lithium secondary battery is approximately 120° C., and thus, it is desirable to heat-treat the soluble polyimide binder at a temperature of 100° C. or higher.

In this regard, the catalyst includes at least one of a dehydrating agent and a chemical curing agent. Preferably, the catalyst includes both a dehydrating agent and a chemical curing agent.

The dehydrating agent may include acetic anhydride. The chemical curing agent may include at least one selected from tertiary amines including 3-methylpyridine, pyridine, triethylamine, and isoquinoline.

The organic solvent may include one or more selected from DMF (dimethylformamide), NMP (N-methyl-2-pyrrolidone), DMSO (Dimethyl Sulfoxide), DMAc (Dimethylacetamide), methyl lactate, ethyl lactate, n-propyl lactate, n-butyl lactate, acetone, diethylacetate, etc.

The soluble polyimide binder for the positive electrode of the lithium secondary battery according to an embodiment of the present disclosure has a solid content of 20 to 23 wt % and a viscosity of 5,000 to 30,000 cps.

Further, regarding the soluble polyimide binder for the positive electrode of the lithium secondary battery according to an embodiment of the present disclosure, a content of a large-sized functional group such as —CF₃ is reduced in the binder, while one or more types of functional groups including —O—, ═SO₂ and —COOH are introduced to the binder, such that the binder exhibits electrode characteristics such as reduced resistance and improved wettability, compared to a PVdF binder or a polyimide binder containing a large amount of the large-sized functional group —CF₃, and thus may improve physical properties such as high heat resistance, safety, and excellent battery performance.

### Lithium Secondary Battery Including Soluble Polyimide Binder for Positive Electrode

A lithium secondary battery including a soluble polyimide binder for a positive electrode of a lithium secondary battery according to an embodiment of the present disclosure includes a positive electrode, a negative electrode, a separator, and an electrolyte solution.

The positive electrode includes a positive electrode active material, a binder, and a conductive material. The positive electrode active material may be any common positive electrode active material used in this technical field. Specifically, high nickel active material may be used as the positive electrode active material. The high nickel active material may include at least one selected from commercially available CM622(LiNi_{0.6}Co_{0.2}Mn_{0.2}), and commercially available NCM811(LiNi_{0.8}CO_{0.1}Mn_{0.1}). Alternatively, the positive electrode active material may include at least one selected from lithium cobaltate composite oxide (LiCoO₂), spinel crystalline lithium manganate composite oxide (LiMn₂O₄), lithium manganate composite oxide (LiMnO₂), lithium nickelate composite oxide (LiNiO₂), lithium iron phosphate (LiFePO₄), lithium manganese phosphate (LiMnPO₄), lithium cobalt phosphate (LiCoPO₄), iron pyrophosphate (Li₂FeP₂O₇), lithium niobate (LiNbO₂), lithium iron oxide (LiFeO₂), lithium magnesium oxide (LiMgO₂), lithium calcium acid composite oxide (LiCaO₂), lithium copper acid composite oxide (LiCuO₂), lithium zinc acid composite oxide (LiZnO₂), lithium molybdate composite oxide (LiMoO₂), lithium tantalate composite oxide (LiTaO₂), lithium tungstate composite oxide (LiWO₂), etc. However, the present disclosure it not limited thereto.

The binder of the positive electrode includes the soluble polyimide binder as described above with reference to FIG. 1. As described above, the soluble polyimide binder has a solid content of 20 to 23 wt % and a viscosity of 5,000 to 30,000 cps.

Further, regarding the soluble polyimide binder for the positive electrode of the lithium secondary battery according to an embodiment of the present disclosure, a content of a large-sized functional group such as —CF₃ is reduced in the binder, while one or more types of functional groups including —O—, ═SO₂ and —COOH are introduced to the binder, such that the binder exhibits electrode characteristics such as reduced resistance and improved wettability, compared to a PVdF binder or a polyimide binder containing a large amount of the large-sized functional group —CF₃.

The negative electrode is spaced apart from the positive electrode and includes a negative electrode active material, a binder, and a conductive material.

The separator is placed between the negative electrode and the positive electrode and serves to prevent a short circuit between the negative electrode and the positive electrode. This separator may be embodied as an insulating thin film with high ion permeability and mechanical strength. Furthermore, a pore diameter of the separator may be generally in a range of 0.01 to 10 μm, and a thickness of the separator may be in a range of 5 to 300 μm. The separator may be made of one selected from polypropylene, polyethylene, glass fiber, non-woven fabric, etc., but is not limited thereto.

The electrolyte solution is impregnated into the negative electrode and the positive electrode. The electrolyte solution may include an electrolyte and a solvent for dissolving the electrolyte therein. The electrolyte of the electrolyte solution may include an electrolyte and a solvent for dissolving the electrolyte. The electrolyte may include one or more types selected from a group consisting of lithium hexafluorophosphate, lithium perchlorate, lithium tetrafluoroborate, lithium trifluoromethanesulfonate, and imide lithium trifluoromethanesulfonate. However, the present disclosure is not limited thereto. The solvent for dissolving the electrolyte therein may include at least one selected from propylene carbonate, ethylene carbonate, dimethyl carbonate, diethyl carbonate, ethylmethyl carbonate, γ-butyrolactone, etc. However, the present disclosure is not limited thereto.

As described above so far, in the soluble polyimide binder for the positive electrode of the lithium secondary battery, the preparation method thereof, and the lithium secondary battery including the same according to the present disclosure, while a content of the large-sized functional group such as —CF₃ is reduced in the binder, one or more types of functional groups including —O—, ═SO₂ and —COOH are introduced to the binder, such that the binder exhibits electrode characteristics such as reduced resistance and improved wettability, compared to a PVdF binder or a polyimide binder containing a large amount of the large-sized functional group —CF₃.

As a result, in the soluble polyimide binder for the positive electrode of the lithium secondary battery, the preparation method thereof, and the lithium secondary battery including the same according to the present disclosure, the binder may have improved interfacial adhesion with the positive electrode active material, and may have excellent thermal stability, and may secure electrode structure stability at high voltage, thereby improving physical properties such as high heat resistance, safety, and excellent battery performance.

### EXAMPLE

Hereinafter, the composition and effects of the present disclosure will be described in more detail through preferred examples of the present disclosure. However, the examples are presented as desirable embodiments of the present disclosure and cannot be interpreted as limiting the present disclosure in any way.

Information not described herein may be technically inferred by anyone skilled in this technical field. Thus, description thereof will be omitted.

### 1. Manufacturing of Lithium Secondary Battery

### Present Example 1

### Preparation of Soluble Polyimide Binder

6-FDA (70.0 g, 0.16 mol, CAS NO.1107-00-2), ODA (25.2 g, 0.13 mol, CAS NO. 101-80-4) and DABA (4.80 g, 0.03 mol, CAS NO. 535-87-5) were added to 400 g of NMP (N-methyl-2-pyrrolidone), followed by stirring at a speed of 200 rpm for 12 hours at 25° C. in a nitrogen gas atmosphere. Thus, the polyamic acid was polymerized.

Next, 3.24 g of acetic anhydride and 2.22 g of 3-methylpyridine (3-picoline) were added to the prepared polyamic acid, followed by stirring for 2 hours at a temperature of 25° C., and the resulting product was imidized via high-temperature heating thereto at 180° C. for 12 hours in a nitrogen gas atmosphere. Thus, the soluble polyimide binder was prepared.

### Manufacturing of Lithium Secondary Battery

A positive electrode slurry was prepared using 92.5 wt % of 0.3Li₂MnO₃0.7Li₂MnO_{0.2}Ni_{0.6}Co_{0.2}O₂ (3 μm diameter) as the positive electrode active material, 3.5 wt % of super-C as the conductive material, and 4 wt % of the soluble polyimide binder solution as the binder.

Next, the prepared positive electrode slurry was applied on an aluminum foil as a positive electrode current collector, dried at 110° C. for 120 minutes, and compressed to prepare a positive electrode for a lithium secondary battery with a thickness of 35 μm.

Furthermore, a graphite negative electrode was used as a counter electrode. LiPF₆ was dissolved, at 1 M, in a mixed solvent of ethylene carbonate (EC) and ethylmethyl carbonate (EMC) at a volume ratio of 3:7, thereby producing LiPF₆/EC:EMC as the electrolyte solution. Thus, the lithium secondary battery was manufactured using the positive electrode, the graphite negative electrode, and the LiPF₆/EC:EMC as the electrolyte solution.

### Present Example 2

A lithium secondary battery was manufactured in the same manner as Present Example 1, except that when preparing the soluble polyimide binder, m-BAPS (59.5 g, 0.14 mol, Cas NO. 30203-11-3) and DPDA (40.5 g, 0.14 mol, CAS NO. 2420-87-3) were added to 400 g of NMP (N-methyl-2-pyrrolidone).

### Present Example 3

A lithium secondary battery was manufactured in the same manner as Present Example 1, except that when preparing soluble polyimide binder, m-BAPS (55.7 g, 0.13 mol, Cas NO. 30203-11-3), DABA (2.2 g, 0.01 mol, CAS NO. 535-87-5) and BPDA (40.5 g, 0.14 mol, CAS NO. 2420-87-3) was added to 400 g of NMP (N-methyl-2-pyrrolidone).

### Comparative Example 1

A lithium secondary battery was manufactured in the same manner as Present Example 1, except that commercially available PVdF (from Aldrich) was used as a positive electrode binder.

### Comparative Example 2

A lithium secondary battery was manufactured in the same manner as Present Example 1, except that when preparing soluble polyimide binder, 6-FDA (60.8 g, 0.14 mol, CAS NO.1107-00-2), DABA (4.2 g, 0.03 mol, CAS NO. 535-87-5) and TFMB (35.0 g, 0.11 mol, CAS NO. 341-58-2) was added to 400 g of NMP (N-methyl-2-pyrrolidone).

### 2. Physical Property Evaluation

Table 1 shows the physical property evaluation results of the positive electrode binder according to each of Present Examples 1 to 3 and Comparative Examples 1 to 2.

### 1) Glass Transition Temperature (Tg)

The glass transition temperature of the positive electrode binder was measured using DSC3 from METTLER TOLEDO.

### 2) Limiting Oxygen Index (LOI)

The limiting oxygen index value refers to the lowest volume concentration of oxygen that may be required to maintain the combustion when the combustible material is combusted staring from a top of the combustible material standing upright, and acts as a measure of combustibility and flame retardancy.

TABLE 1

| | Glass transition | Limiting oxygen |
|---|---|---|
| Examples | temperature (Tg) | index (LOI) |
| Comparative Example 1 | −35° C. | 44.0% |
| Comparative Example 2 | 126° C. | 53.2% |
| Present Example 1 | 215° C. | 51.7% |
| Present Example 2 | 227° C. | 53.4% |
| Present Example 3 | 220° C. | 52.8% |

As shown in Table 1, the positive electrode binder prepared according to each of Present Examples 1 to 3 exhibited a glass transition temperature (Tg) of over 100° C., while the positive electrode binder prepared according to Comparative Example 1 exhibited a glass transition temperature of −35° C. below a target value.

In addition, based on a result of the flame retardancy test, it is confirmed that the positive electrode binder prepared according to each of Present Examples 1 to 3 exhibits an LOI value of 50% or higher, and thus has excellent flame retardancy. On the other hand, it is confirmed that the positive electrode binder prepared according to Comparative Example 1 exhibits an LOI value smaller than 50%, indicating that the flame retardancy thereof is poor compared to that of each of Present Examples 1 to 3.

### 3. Microstructure Observation

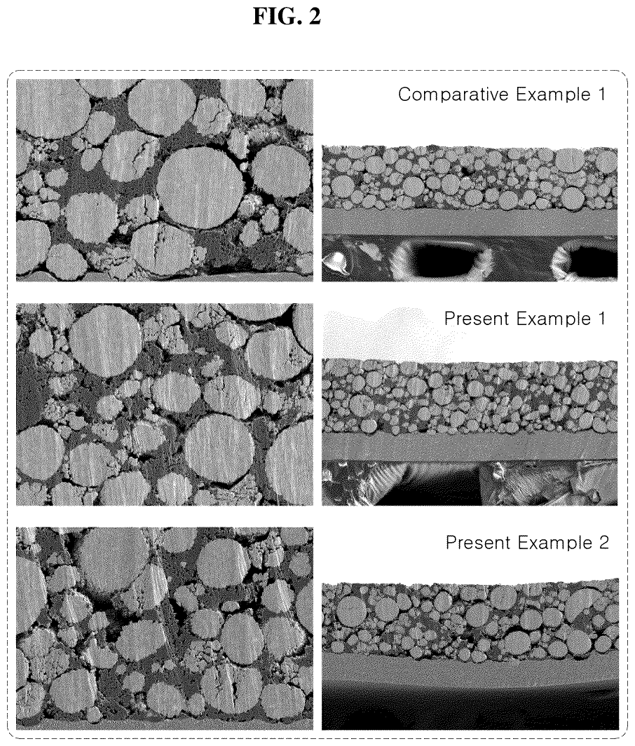

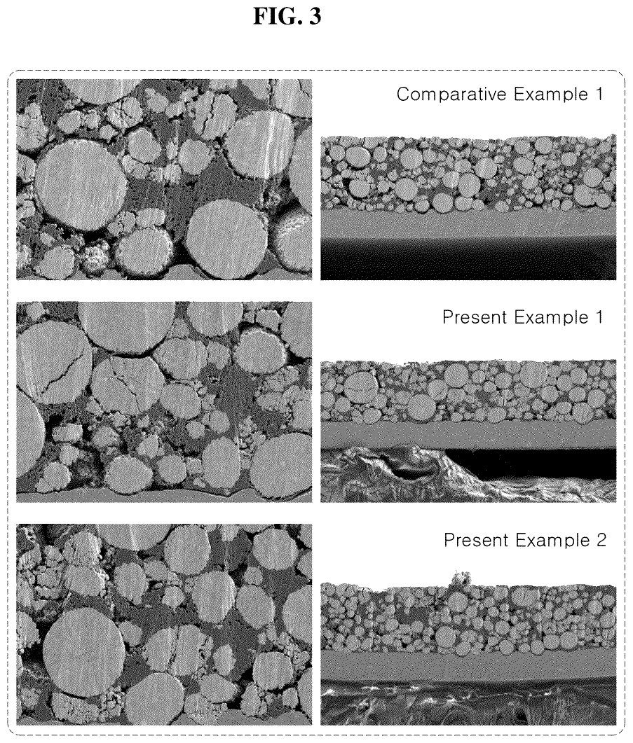

FIG. 2 and FIG. 3 are SEM pictures showing a cut surface of a positive electrode after a charge and discharge test of the lithium secondary battery according to each of Present Examples 1 to 2 and Comparative Example 1. In this regard, FIG. 2 and FIG. 3 show the cut surfaces of the positive electrode in the initial and final states after charging and discharging the battery 2 times and 50 times under the condition of 0.1 C within an operation voltage range of 2.7 to 4.6V at 45° C.

As shown in FIG. 2 and FIG. 3, based on the results of comparing the SEM pictures of the cut surfaces of the positive electrode at the beginning and end of the charge and discharge test of the lithium secondary battery according to Present Examples 1 to 2 and Comparative Example 1 with each other, Present Examples 1 to 2 show no significant difference from Comparative Example 1, thus indicating that good adhesion is achieved between the positive electrode plate (positive electrode current collector) and the active material electrode layer (positive electrode slurry) without detachment therebetween.

### 4. Charge/Discharge Test

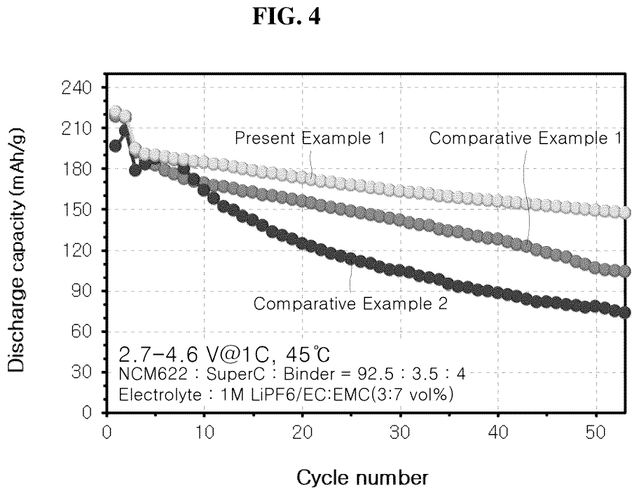

FIG. 4 is a graph showing the result of a high-temperature and high-voltage charge/discharge test on the lithium secondary battery according to each of Present Example 1 and Comparative Examples 1 to 2.

As shown in FIG. 4, the high temperature and high voltage charge and discharge test result on the lithium secondary battery according to each of Present Example 1 and Comparative Examples 1 to 2 is shown. In this regard, the charge/discharge test was conducted 50 times at 45° C. and under 1 C condition within an operation voltage range of 2.7 to 4.6V.

Based on a result of the charge and discharge test, it is identified that the lithium secondary battery according to Present Example 1 in which the content of the —CF₃ functional group in the positive electrode binder is reduced and the —O— functional group is introduced to the binder has clearly increased discharge capacity at high temperature and high voltage, compared to the lithium secondary battery according to each of Comparative Examples 1 to 2.

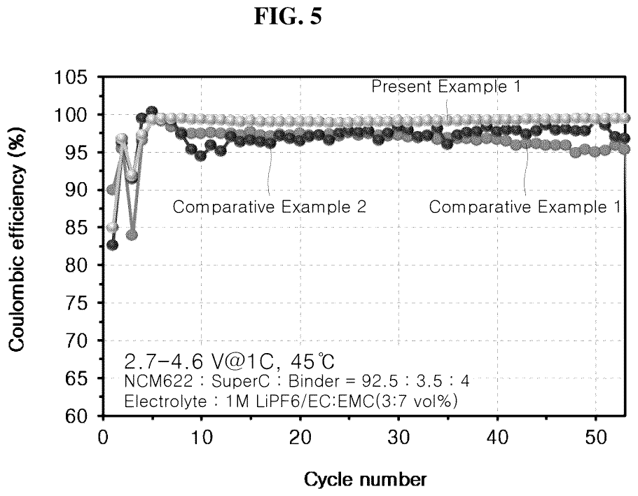

FIG. 5 is a graph showing the cycle characteristics of the lithium secondary battery according to each of Present Example 1 and Comparative Examples 1 to 2.

As shown in FIG. 5, the cycle characteristics result on the lithium secondary battery according to each of Present Example 1 and Comparative Examples 1 to 2 is shown. In this regard, charging and discharging was performed 50 times at 45° C. and under 1 C condition within the operation voltage range of 2.7 to 4.6V.

As may be seen based on the cycle characteristics results, the lithium secondary battery according to Present Example 1 in which the content of the —CF₃ functional group in the positive electrode binder is reduced and the ═SO₂ functional group is introduced to the binder has increased coulombic efficiency compared to the lithium secondary battery according to Comparative Examples 1 to 2.

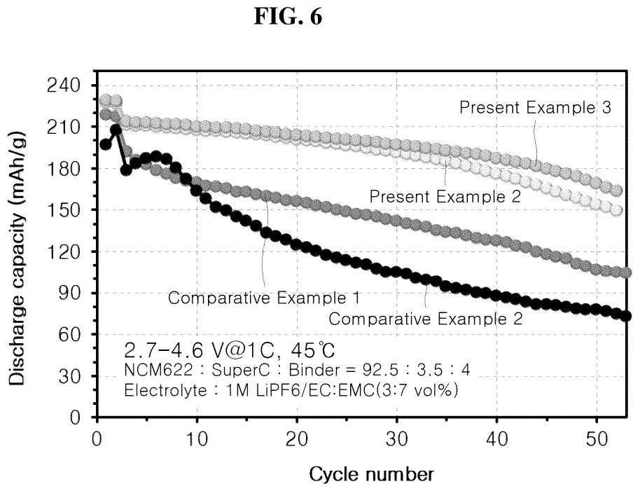

FIG. 6 is a graph showing a result of a high-temperature and high-voltage charge/discharge test on the lithium secondary battery according to each of Present Examples 2 to 3 and Comparative Examples 1 to 2.

As shown in FIG. 6, the high temperature and high voltage charge and discharge test result on the lithium secondary battery according to each of Present Examples 2 to 3 and Comparative Examples 1 to 2 is shown. In this regard, the charge/discharge test was conducted 50 times at 45° C. and under 1 C condition within the operation voltage range of 2.7 to 4.6V.

Based on a result of the charge and discharge test, it may be identified that each of the lithium secondary battery according to Present Example 2 in which the content of the —CF₃ functional group in the positive electrode binder is reduced and the ═SO₂ functional group is introduced to the binder, and the lithium secondary battery according to Present Example 3 in which the content of the —CF₃ functional group in the positive electrode binder is reduced and the ═SO₂ functional group and the —COOH functional group are introduced to the binder has a marked increase in the discharge capacity in the charge and discharge test at high temperature and high voltage, compared to the lithium secondary battery according to each of Comparative Examples 1 to 2.

The above description focuses on the embodiment of the present disclosure, but various changes or modifications may be made at the level of a technician with ordinary knowledge in the technical field to which the present disclosure belongs. These changes and modifications may belong to the present disclosure as long as they do not go beyond the scope of the technical idea provided by the present disclosure. Therefore, the scope of the rights of the present disclosure should be determined by the claims described below.

### DESCRIPTION OF REFERENCE NUMERALS

S110: Dissolution step
S120: Polymerization step
S130: High temperature heating step

What is claimed is:

1. A method for preparing a soluble polyimide binder for a positive electrode of a lithium secondary battery, the method comprising:
(a) dissolving a diamine-based monomer and a dianhydride monomer in an organic solvent to prepare a mixed solution;
(b) polymerizing the mixed solution to produce polyamic acid and then adding a catalyst thereto; and
(c) heating the polyamic acid having the catalyst added thereto to a high temperature of 160 to 180° C. to imidize the polyamic acid to produce the soluble polyimide binder,
wherein in the (c), the soluble polyimide binder includes a copolymer containing a repeating unit represented by a following Chemical Formula 1, a repeating unit represented by a following Chemical Formula 2, and a repeating unit represented by a following Chemical Formula 3, and the soluble polyimide binder has a glass transition temperature of 100 to 300° C.: 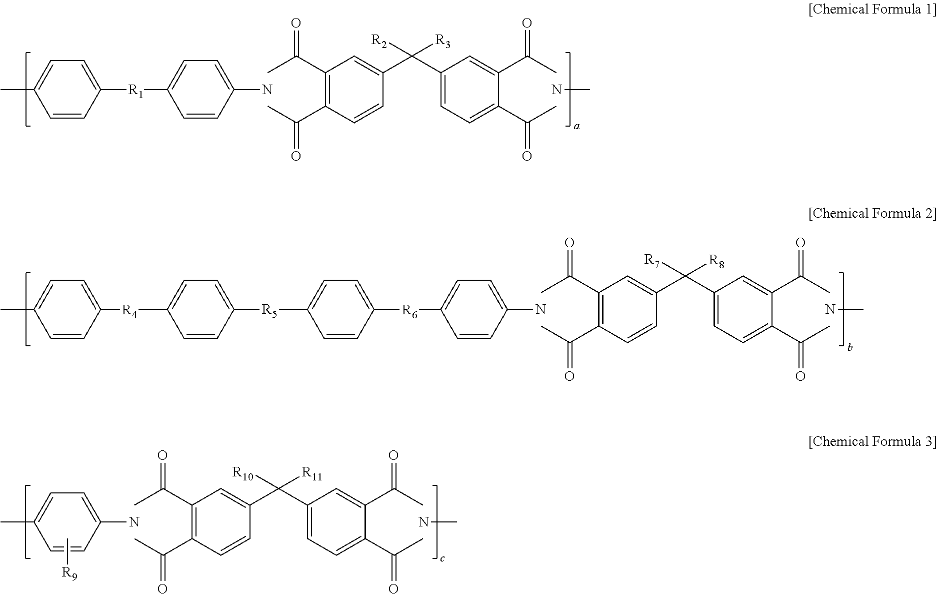
where in the Chemical Formula 1, the Chemical Formula 2, and the Chemical Formula 3, each of R₁, R₄ to R₆, and R₉ independently represents at least one functional group selected from a group consisting of a sulfonic acid group, an ether group, and a carboxyl group,
each of R₂, R₃, R₇, R₈, R₁₀, and R₁₁ independently represents one functional group selected from CH₃₋ₓFₓ,
wherein x is an integer from 1 to 3, and each of a, b, and c is independently an integer from 2 to 200.

2. The method of claim 1, wherein in the (b), the polymerization is conducted for 3 to 12 hours under a temperature condition of −10° C. to 25° C.

3. The method of claim 1, wherein in the (b), the catalyst includes at least one of a dehydrating agent and a chemical curing agent,
wherein the dehydrating agent includes acetic anhydride,
wherein the chemical curing agent is selected from tertiary amines including 3-methylpyridine, pyridine, triethylamine, and isoquinoline.

4. The method of claim 1, wherein in the (c), the high temperature heating is conducted for 10 to 30 hours in a nitrogen atmosphere.

5. The method of claim 1, wherein in the (c), the soluble polyimide binder has a solid content in a range of 20 to 23 wt % and has a viscosity in a range of 5,000 to 30,000 cps.

6. A soluble polyimide binder for a positive electrode of a lithium secondary battery, wherein the soluble polyimide binder comprises:
a copolymer containing a repeating unit represented by a following Chemical Formula 1, a repeating unit represented by a following Chemical Formula 2, and a repeating unit represented by a following Chemical Formula 3;
a catalyst; and
an organic solvent,
wherein the soluble polyimide binder has a glass transition temperature of 100 to 300° C.: 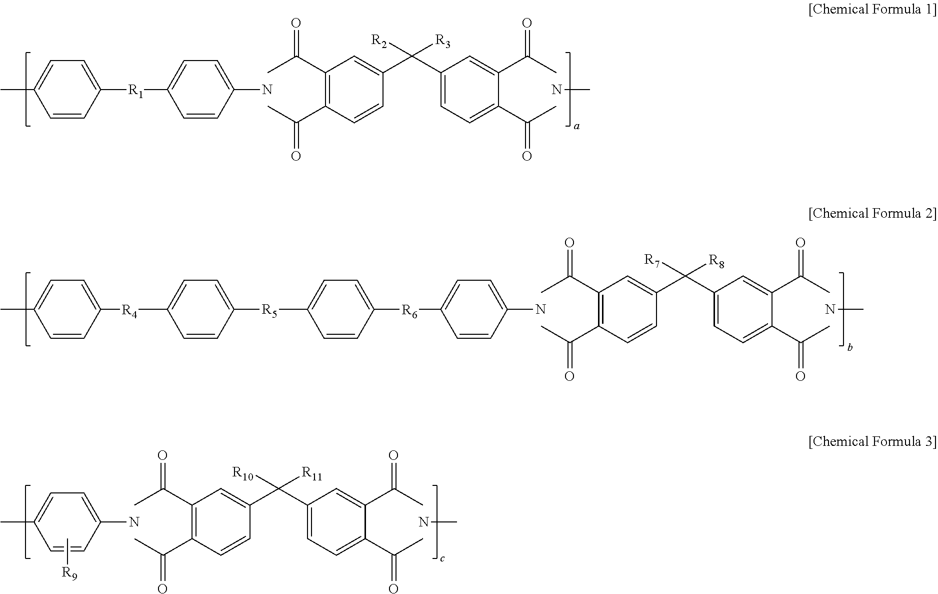
where in the Chemical Formula 1, the Chemical Formula 2, and the Chemical Formula 3, each of R₁, R₄ to R₆, and R₉ independently represents at least one functional group selected from a group consisting of a sulfonic acid group, an ether group, and a carboxyl group,
each of R₂, R₃, R₇, R₈, R₁₀, and R₁₁ independently represents one functional group selected from CH₃₋ₓFₓ,
wherein x is an integer from 1 to 3, and each of a, b, and c is independently an integer from 2 to 200.

7. The soluble polyimide binder of claim 6, wherein the catalyst includes at least one of a dehydrating agent and a chemical curing agent,
wherein the dehydrating agent includes acetic anhydride,
wherein the chemical curing agent is selected from tertiary amines including 3-methylpyridine, pyridine, triethylamine, and isoquinoline.

8. The soluble polyimide binder of claim 6, wherein the soluble polyimide binder has a solid content in a range of 20 to 23 wt % and has a viscosity in a range of 5,000 to 30,000 cps.

9. A lithium secondary battery comprising:
a positive electrode including an active material, a binder, and a conductive material;
a negative electrode spaced apart from the positive electrode and including a negative electrode active material, a binder, and a conductive material;
a separator disposed between the negative electrode and the positive electrode to prevent short circuit between the negative electrode and the positive electrode; and
an electrolyte solution impregnated into the negative electrode and the positive electrode,
wherein the binder of the positive electrode is a soluble polyimide binder, wherein the soluble polyimide binder includes:
a copolymer containing a repeating unit represented by a following Chemical Formula 1, a repeating unit represented by a following Chemical Formula 2, and a repeating unit represented by a following Chemical Formula 3;
a catalyst; and
an organic solvent,
wherein the soluble polyimide binder has a glass transition temperature of 100 to 300° C.: 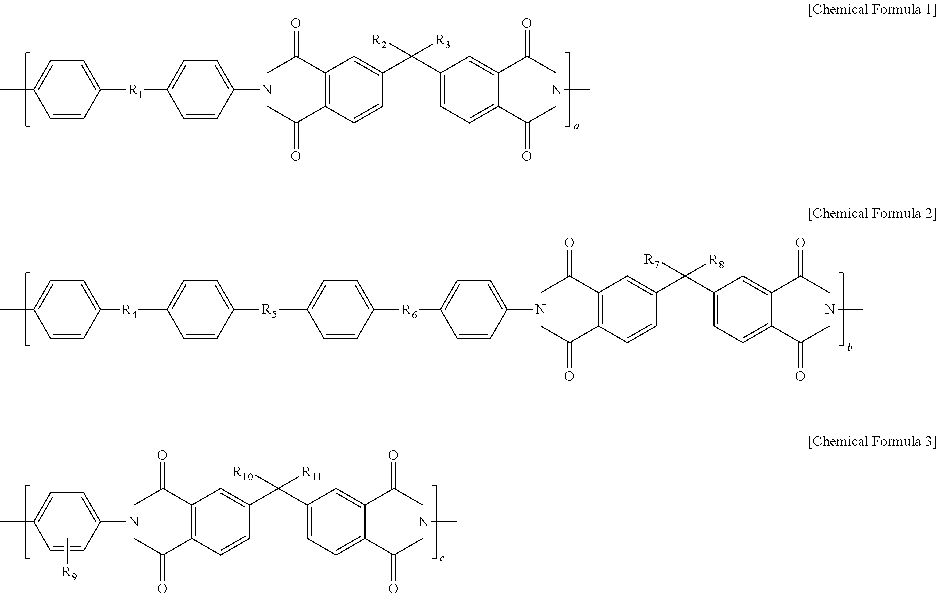
where in the Chemical Formula 1, the Chemical Formula 2, and the Chemical Formula 3, each of R₁, R₄ to R₆, and R₉ independently represents at least one functional group selected from a group consisting of a sulfonic acid group, an ether group, and a carboxyl group,
each of R₂, R₃, R₇, R₈, R₁₀, and R₁₁ independently represents one functional group selected from CH₃₋ₓFₓ,
wherein x is an integer from 1 to 3, and each of a, b, and c is independently an integer from 2 to 200.
